(19) United States
(12) Patent Application Publication
(10) Pub. No.: US 2005/0281543 A1
(43) Pub. Date: Dec. 22, 2005

(54) Information processing apparatus

(76) Inventors: Masaru Takahashi, Yokohama (JP); Yusuke Yatabe, Yokohama (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(21) Appl. No.: 11/148,356

(22) Filed: Jun. 9, 2005

(30) Foreign Application Priority Data
Jun. 17, 2004 (JP) 2004-179144

(51) Int. Cl. H04N 5/76; H04N 5/225

(52) U.S. Cl. 386/117; 386/125

(57) ABSTRACT

A moving picture recording system includes a communicable moving picture recording apparatus and a mobile terminal. In this case, the communicable moving picture recording apparatus has a recording module which records a moving picture in a recording medium and a transmitting module which transmits information indicating an in-recording state, while the recording module is recording the moving picture in the recording medium. The mobile terminal has a receiving module which receives the information indicating the in-recording state and an informing module which informs a user that the communicable moving picture recording apparatus is recording a moving pictures when the information indicating the in-recording state is received.

### BACKGROUND OF THE INVENTION

The present invention relates to an information processing apparatus.

JP-A-2004-32228 discloses a technique which is designed to “provide a video distribution system that transmits video data, that has been shot by an imaging device to a mobile terminal or information terminal, through another mobile terminal and a wireless digital communication network, so that the shot video image can be streamed by the terminal side substantially at the same time as the shooting.” This is accomplished by “compressing and then transmitting video data of a moving picture shot by an imaging device 4 of a video transmitting mobile terminal 1 serially to a video distribution server 2 through a wireless digital communication network, distributing the video data transmitted from the video transmitting mobile terminal 1 immediately and serially from the video distribution server to a video playing mobile terminal 3 or video playing information terminal 6, and decoding and displaying, on a display device the video data received by the video playing mobile terminal 3 or the video playing information terminal 6 immediately, almost without a delay time.”

The technology involves a video distribution system that compresses and then transmits video data of a moving picture, that has been shot by an imaging device, through a wireless communication network and distributes it from a video distribution server to a mobile terminal to effect a display thereof.

However, this technology does not consider the operability in the distribution of a video image, which is being recorded and shot, to a mobile terminal. In other words, though the conventional technology can display a moving picture that has been shot by an imaging device on a mobile terminal, a user of the mobile terminal cannot determine whether the currently viewed moving picture is being recorded or not. Accordingly, the operability can be improved by displaying information indicating whether the currently viewed moving picture is being recorded or not on the mobile terminal, for example.

### SUMMARY OF THE INVENTION

It is an object of of the present invention to improve the operability of an information processing apparatus.

As an embodiment of the present invention, that is a moving picture recording system, including a communicable moving picture recording apparatus and a mobile terminal, wherein the communicable moving picture recording apparatus has a recording module which records a moving picture in a recording medium and a transmitting module which transmits to the mobile terminal information indicating an in-recording state, while the recording module is recording the moving picture in the recording medium, and the mobile terminal has a receiving module which receives information indicating the in-recording state and an informing module which informs a user that the communicable moving picture recording apparatus is recording a moving picture when the information indicating the in-recording state is received.

According to the present invention, the operability of an information processing apparatus can be improved.

Furthermore, the operability of a video camera can be improved.

### BRIEF DESCRIPTION OF THE DRAWINGS

These and other features, objects and advantages of the present invention will become more apparent from the following description, when taken in conjunction with the accompanying drawings, wherein:

FIG. 1 is a block diagram of a moving picture recording system according to the present invention;

FIG. 2 is a flowchart illustrating steps in a process of recording a moving picture according to the present invention; and

FIGS. 3A to 3C are diagrams showing examples of displayed images according to the present invention.

### DESCRIPTION OF THE PREFERRED EMBODIMENT

An exemplary embodiment of the present invention will be described below with reference to the drawings.

In this embodiment, a communicable moving picture recording apparatus represents an example of an information processing apparatus according to the present invention. Also, the invention may be implemented in consideration of the following points. Though conventional technologies can distribute to a mobile terminal a video image that is being shot, the picture quality typically is low. Thus, the conventional technologies are disadvantageously not suitable for recording by use of a video camera for consumer-use or monitoring-use, which means that the conventional technologies do not consider the distribution of a video image, which is being recorded at high quality, to a mobile terminal. On the other hand, there is a video camera that is widely used which can encode moving picture data by compression encoding, such as MPEG-2, and record the result with a high picture quality in a recording medium, such as a DVD. With the use of streaming technology, a moving picture distributed through a wireless public network, such as a cellular telephone network and the Internet, can be viewed in real time on a mobile terminal, such as a cellular telephone and a PDA. In this case, since the moving picture cannot occupy a large-capacity transmission channel, unlike broadcasting, the moving picture often may be encoded by high compression encoding that is suitable for communication, such as MPEG-4. Accordingly, this is applied to allow the recording of shot moving picture data in a recording medium at a high picture quality and, at the same time, to permit monitoring of the moving picture data on a mobile terminal that is connected to the Internet or a public network of cellular telephones, for example, so that the operability can be improved. In this embodiment, a moving picture is encoded and recorded by MPEG-2, and that is encoded and transmitted by MPEG-4 to a mobile terminal.

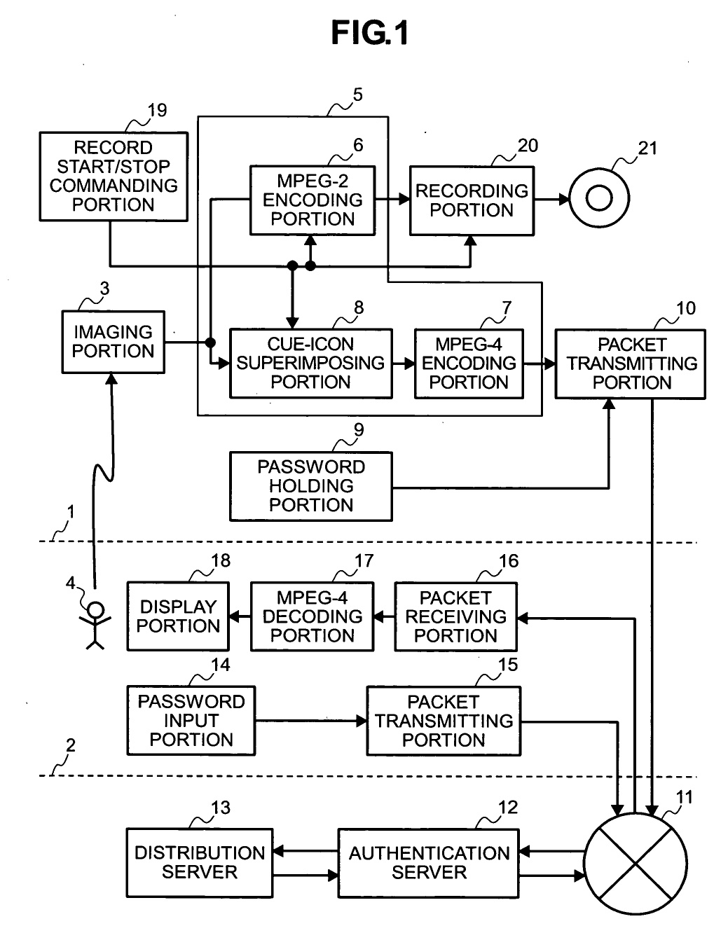

FIG. 1 is a block diagram of a moving picture recording system according to the present invention. The part illustrated above the broken line 1 represents a communicable moving picture recording apparatus. The part illustrated between the broken line 1 and the broken line 2 represents a subject and a mobile terminal carried by the subject. The part illustrated below the broken line 2 represents a public network and a service provider.

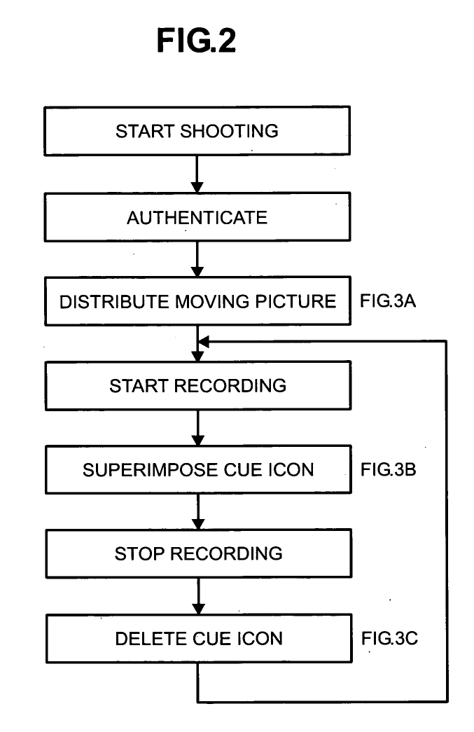

FIG. 2 is a flowchart illustrating steps in the process of recording and distribution of a moving picture according to the present invention. An example of the operation of the first embodiment will be described below with reference to FIGS. 1 and 2. First of all, the operation of a communicable moving picture recording apparatus is started by a photographer, not shown, and shooting is started. An imaging portion 3 shoots a subject 4 and creates moving picture data. The system of FIG. 1 includes a dual encoder 5 that simultaneously creates a bit stream for recording and a bit stream for distribution. In this embodiment, the dual encoder 5 includes an MPEG-2 encoding portion 6, an MPEG-4 encoding portion 7, and a “cue” icon superimposing portion 8.

Then, a password held by a password holding portion 9 is transmitted to a public network 11 through a packet transmitting portion 10 and is delivered to an authentication server 12 that is used by a service provider. Notably, the password can be changed by the photographer at any time.

Next, a bit stream for distribution, which is encoded by the MPEG-4 encoding portion 7, is transmitted to the public network 11 through the packet transmitting portion 10 and is delivered to the distribution server 13 of the service provider. On the other hand, the subject 4 inputs a password through a password input portion 14 of his/her hand-held mobile terminal. The input password is transmitted to the public network 11 through a packet transmitting portion 15 and is delivered to the authentication server 12 of the service provider. The authentication server 12 compares the received input password with the previously received password of the communicable moving picture recording apparatus. If they agree, the authentication server 12 permits the distribution. If the distribution is permitted, the bit stream for distribution is distributed from the distribution server 13 to a packet receiving portion 16 through the public network 11.

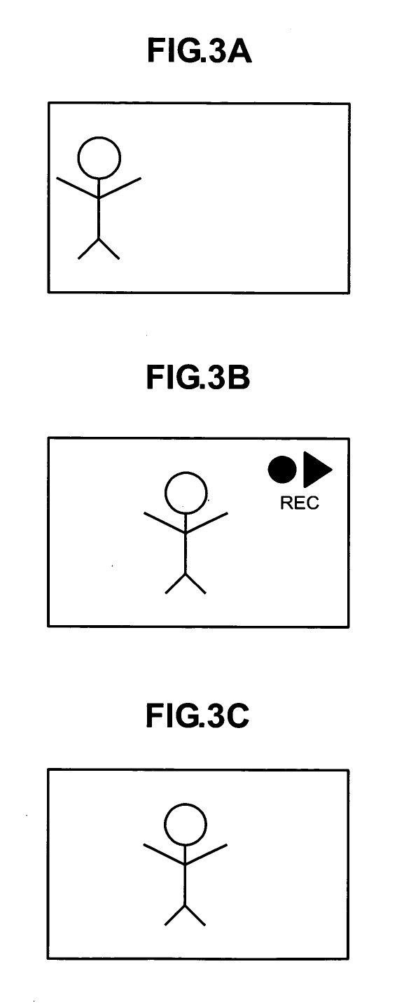

The distributed bit stream is then decoded by the MPEG-4 decoding portion 17, and the image being shot is displayed on a display portion 18. FIG. 3A shows an example of the displayed image on the display portion 18 at that time. In this way, the subject can check to see how he/she appears through his/her hand-held mobile terminal. Here, when the subject desires to appear at the center of the view, the subject may orally communicate such a request to the photographer, such that how he/she appears in the view can be changed.

When the photographer commands the start of recording through actuation of a REC button, for example, the command to start recording is transmitted from a record start/stop commanding portion 19 to the MPEG-2 encoding portion 6, a recording portion 20 and the “cue” icon superimposing portion 8. The MPEG-2 encoding portion 6 creates a bit stream for recording, and the recording portion 20 records the created bit stream in a recording medium 21, such as an optical disk, a magnetic disk, a semiconductor memory or other types of storage devices, so that the recording can be started. On the other hand, the “cue” icon superimposing portion 8 superimposes an icon indicating an “in-recording” state on the input image data supplied to the MPEG-4 encoding portion 7. The image having the icon thereon is distributed and is displayed on the display portion 18. FIG. 3B shows an example of the displayed image of the display portion 18 at that time. In this way, the subject 4 can check the fact that the recording has been started through observation of his/her hand-held mobile terminal. Here, the information indicating the “in-recording” state may be distributed in another packet and be displayed in an On-Screen-Display manner on the mobile terminal, instead by the superimposition on the image data.

In order to stop recording, a command to stop recording is transmitted from the record start/stop commanding portion 19 to the MPEG-2 encoding portion 6, recording portion 20 and “cue” icon superimposing portion 8. The operation of the MPEG-2 encoding portion 6 and recording portion 20 will stop in response thereto, and the icon no longer will be superimposed on the image. FIG. 3C shows an example of the displayed image of the display portion 18 at that time.

Up to this point, a case has been described in which the mobile terminal is carried by only by the subject. However, a simultaneous distribution may be implemented by inputting a password through a mobile terminal that a third party carries. Thus, the multi-viewer function can be implemented by mobile terminals, such as cellular telephones that many people have, and the operability in shooting, therefore, can be improved.

Though the foregoing description illustrates an example in which information indicating the “in-recording” state is superimposed on a displayed image, the following information additionally may be superimposed. For example, an elapsed time from the start of recording, a remaining recordable time (or remaining capacity) of a recording medium and/or a remaining amount of a battery life, may be superimposed and displayed on a mobile terminal. When a subject has access to these kinds of information, not only the photographer, but also the subject, can consider how long the shooting will take, which improves the operability. Furthermore, for example, an auto-iris control mode (such as a standard mode, a sport mode and a night-view mode) and/or a mode relating to picture quality (such as a high picture quality mode and a low picture quality mode) may be superimposed on a video signal to be transmitted to a transmission channel and may be displayed on a mobile terminal. In this case, when the low quality mode is defined, though a subject desires shooting at a high picture quality, the subject can tell the photographer to switch to the high picture quality mode, which improves the operability.

In addition to the features described above, a mobile terminal may not only display, but also record, a received video image. This can be achieved by providing the mobile terminal with a recording portion which records a received video image in a recording medium. In this case, data of a shot moving picture is left not only on the photographer side, but also on the subject side, so that the subject can view the shot moving picture at any time. This eliminates the labor for a subject to receive moving picture data from the photographer through a recording medium or over a communication conventionally, which improves the operability.

Though, in this embodiment, a moving picture is encoded and recorded by MPEG-2 and is also encoded and transmitted by MPEG-4 to a mobile terminal, the encoding is not limited to such two kinds of encoding. Other various kinds of encoding are applicable. Furthermore, the invention does not always require two different kinds of encoding for recording and transmission, but may adopt one kind of encoding.

Though the description provided above is directed to a combination of a communicable moving picture recording apparatus and a mobile terminal, the invention is not limited thereto, but is applicable to various types of apparatus. For example, the invention is also suitable for a television telephone function carried out between cellular telephones with cameras. In this case, like the case exemplified in the foregoing description, when a moving picture shot by a cellular telephone of User A is transmitted to a cellular telephone of User B, information indicating the “in-recording” state may be superimposed thereon, while the moving picture is being recorded by the cellular telephone of User A, and it may be transmitted from the cellular phone of User A to the cellular phone of User B. Alternatively, when a moving picture shot by the cellular telephone of User A is transmitted to the cellular telephone of User B, information indicating the “in-recording” state may be transmitted in a different packet from the cellular telephone of User A to the cellular telephone of User B, and it may be displayed in an On-Screen-Display manner by the cellular telephone of the user B, while the moving image shot by the cellular telephone of User A is not being recorded, but the moving picture received from User B is being recorded by the cellular telephone of User A. In this case, User B can recognize that the moving picture shot by himself/herself is being recorded by the cellular telephone of User A and can prevent or interrupt recording by User A without notice, which improves the operability. Notably, television telephones serving as cellular telephones do not always require an authentication server and/or a distribution server as described above.

In addition to the arrangement exemplified in the description presented above, a microphone may be provided to a mobile terminal, and the voice of a subject may be input therethrough. Then, the voice may be transmitted to a communicable moving picture recording apparatus by using a communication function, and the communicable moving picture recording apparatus may compression-encode the received voice and a video image together. In this case, even when the subject and the photographer are far away from each other, and the subject's voice cannot be picked up by the microphone of the communicable moving picture recording apparatus, the subject's voice can be recorded by the microphone of the mobile terminal used by the subject, which improves the operability. Alternatively, a microphone and a speaker may be provided to the communicable moving picture recording apparatus, and a microphone and a speaker may be provided to the mobile terminal. Thus, the photographer and the subject can contact each other at any time, including during the recording time. In this case, the photographer and the subject can talk even when the subject needs to request something of the photographer, like the embodiment described above, but cannot orally communicate the request easily because the photographer and the subject are far away from each other, which improves the operability.

While, in the arrangement exemplified in the description presented above, the information indicating the “in-recording” state transmitted from the communicable moving picture recording apparatus is displayed on the display portion of the mobile terminal, the information may be communicated to the subject by sound, light, vibrations and so on, instead of, or in addition to, use of the display device. In this case, the subject can recognize that the recording has started even while the subject is not watching the display portion, which improves the operability.

Though the description presented above illustrates the recording and distribution of a moving picture, the present invention is not limited to a moving picture. For example, the invention is also applicable to communication of a still image. A still image is generally monitored (on the moving image) in order to determine the angle of view before recording, and the monitor screen (moving image) is transmitted to the mobile terminal. Then, when a still image is shot/recorded, the recorded still image and information indicating the state of recording are transmitted to the mobile terminal. In this case, the subject can send to the photographer a request relating to the angle of view based on the monitor image and also can recognize that the still image has been recorded. Furthermore, the subject can check the shot/recorded still image. Thus, the operability can be improved.

Finally, while various modifications and examples of application of the present invention have been described, it is apparent that the invention is not limited thereto.

While we have shown and described several embodiments in accordance with our invention, it should be understood that the disclosed embodiments are susceptible to changes and modifications without departing from the scope of the invention. Therefore, we do not intend to be bound by the details shown and described herein, but intend to cover all such changes and modifications as a fall within the ambit of the appended claims.

1. A moving picture recording system comprising:
a communicable moving picture recording apparatus; and
a mobile terminal,
wherein the communicable moving picture recording apparatus has a recording module which records a moving picture in a recording medium and a transmitting module which transmits information indicating an in-recording state while the recording module is recording the moving picture in the recording medium to the mobile terminal; and
the mobile terminal has a receiving module which receives information indicating the in-recording state and an informing module which informs a user that the communicable moving picture recording apparatus is recording a moving picture when the information indicating the in-recording state is received.

2. A communicable moving image recording apparatus comprising:
a recording module which records a moving picture in a recording medium; and
a transmitting module which transmits information indicating an in-recording state when the recording module is recording a moving picture in the recording medium to a transmission channel.

3. A communicable moving picture recording apparatus comprising:
an imaging module;
an encoding module which encodes an output signal of the imaging module;
a recording module which records an output signal of the encoding module in a recording module; and
a transmitting module which transmits an output signal of the encoding module to a mobile terminal,
wherein the transmitting module transmits information indicating an in-recording state to the mobile terminal while the recording module is recording.

4. A communicable moving picture recording apparatus comprising:
an encoding module which creates a first bit stream and a second bit stream from moving picture data;
a recording module which records the first bit stream in a recording medium; and
a transmitting module which transmits the second bit stream to a transmission channel,
wherein the encoding module superimposes information indicating an in-recording state on the second bit stream while the recording module is recording the first bit stream.

5. A moving picture recording system comprising:
a communicable moving picture recording apparatus having an encoding module which creates a first bit stream and a second bit stream from shot moving picture data; a recording module which records the first bit stream in a recording medium; and a transmitting module which transmits the second bit stream to a transmission channel, in which the encoding module superimposes information indicating an in-recording state on the second bit stream while the recording module is recording;
a server placed on the transmission channel, the server receiving and distributing the second bit stream; and
multiple terminals which receive, decode and display the distributed second bit stream.

6. A communicable moving picture recording apparatus comprising:
a receiving module which receives moving picture data shot by an imaging module from a mobile terminal having the imaging module;
a recording module which records the received moving picture data in a recording medium; and
a transmitting module which transmits information indicating an in-recording state to the mobile terminal while the recording module is recording the received moving picture data in the recording medium.

7. A moving picture recording system comprising:
a communicable moving picture recording apparatus and;
a mobile terminal,
wherein the communicable moving picture recording apparatus has:
an imaging module;
an encoding module which creates a bit stream for recording by MPEG2 and a bit stream for distribution by MPEG4 from an output signal of the imaging module;
a recording module which records the bit stream for recording by MPEG2 in a recording medium; and
a transmitting module which transmits the bit stream for distribution by MPEG4 to the mobile terminal;
the encoding module superimposes information indicating an in-recording state on the bit stream for distribution by MPEG4 while the recording module is recording,
the mobile terminal has:
a receiving module which receives the transmitted bit stream for distribution by MPEG4;
a decoding module which decodes the received bit stream for distribution by MPEG4; and
a display module which displays the bit stream for distribution by MPEG4 decoded by the decoding module, the display module displays that the communicable moving picture recording apparatus is recording the bit stream for recording by MPEG2 in a recording medium when the information indicating the in-recording state is superimposed on the bit stream for distribution by MPEG4.

8. A first information processing apparatus in an information processing system having the first information processing apparatus and a second information processing apparatus, the first information processing apparatus comprising:
a recording module which records predetermined information in a recording medium; and
a transmitting module which transmits information indicating an in-recording state to the second information processing apparatus while the recording module is recording the predetermined information in a recording medium.
